(19) United States
(12) Patent Application Publication
(10) Pub. No.: US 2011/0100951 A1
(43) Pub. Date: May 5, 2011

(54) METHOD AND APPARATUS FOR TRANSFERRING CARBONACEOUS MATERIAL LAYER

(75) Inventors: Zhen-Yu Juang, Hsinchu City (TW); Chih-Yu Wu, Taitung County (TW); Ang-Yu Lu, Taichung City (TW); Keh-Chyang Leou, Hsinchu City (TW); Fu-Rong Chen, Hsinchu City (TW); Chuen-Horng Tsai, Hsinchu City (TW)

(73) Assignee: NATIONAL TSING HUA UNIVERSITY, Hsin-Chu (TW)

(21) Appl. No.: 12/703,800

(22) Filed: Feb. 11, 2010

(30) Foreign Application Priority Data
Nov. 3, 2009 (TW) 098137335

(51) Int. Cl. C23F 1/00; B32B 37/02; B32B 38/18

(52) U.S. Cl. 216/13; 156/234; 156/345.2; 156/379.8; 156/499; 156/540; 977/755

(57) ABSTRACT

In a method and apparatus for transferring carbonaceous material layer, a carbonaceous material layer is grown on a growth substrate, and a first continuous conveying unit is used to feed the growth substrate and a transfer material, so that a gluing layer of the transfer material is attached to the carbonaceous material layer on the growth substrate. Then, a transformation device changes a viscosity of the gluing layer for the latter to adhere to the carbonaceous material layer. A second continuous conveying unit is further used to transfer and then separate the mutually adhered transfer material and growth substrate from each other, so that some part of the carbonaceous material layer is transferred onto the gluing layer while other part of the carbonaceous material layer remains on the growth substrate. Thus, at least a one-layer-thickness of the carbonaceous material layer is transferred.

### FIELD OF THE INVENTION

The present invention relates to a method and apparatus for transferring carbonaceous material layer, and more particularly to a simplified method and apparatus for continuously transferring a large-area carbonaceous material layer.

### BACKGROUND OF THE INVENTION

Transparent conductive material plays a very important role in the display and solar energy industries. Most of the common transparent conductive materials are n-type metal oxides, which provide high conductivity through oxygen vacancies in the structure thereof and doping of other ions or chemical compounds. Among others, indium tin oxide (ITO), due to its superior conductivity, has become an irreplaceable choice in the current display industry. However, since there is only limited indium resource on the earth, the cost of ITO target constantly increases in recent years. Further, loss of conductivity occurs when ITO is bent, rendering ITO not suitable for flexible elements. Therefore, there is an imminent need for finding an alternative to ITO.

The discovery of the one-atom-layer and suspended graphene in 2004 by A. K. Geim and his researcher team at Manchester University started a series of researches on graphene. Then, M. S. Fuhrer at Maryland University and other physicists led by him showed that graphene at room temperature has electron mobility higher than that of any other known materials. They also showed that thermal vibration has only very small hindrance to the migration of the electrons in graphene. In graphene, the vibrating atoms at room temperature produce a resistivity of about 1.0 μΩ-cm, which is about 35% less than the resistivity of copper, and making graphene the lowest resistivity material known at room temperature.

However, graphene has far fewer electrons than copper. Therefore, in graphene, electric current is actually carried by a few electrons, which move much faster than the electrons in copper. The mobility of electrons in graphene at room temperature is about 2.0×10⁵ cm²/Vs, which is the highest one in conventional semiconductor known, compared to about 1.4×10³ cm²/Vs in silicon and 7.7×10⁴ cm²/Vs in indium antimonide (InSb), and is twice as faster as the electron mobility of 1.0×10⁵ cm²/Vs in single-walled carbon nanotube (SWCNT).

Mobility determines the speed at which an electronic device can turn on and off. The very high mobility makes graphene very suitable for applications in transistors that are to be switched extremely fast for processing extremely high frequency signals. Mobility can also be expressed as the conductivity of a material. As being affected by the molecules adsorbed on the surface of graphene, the high mobility in graphene is also advantageous for applications in chemical or biochemical sensors. The low resistivity and the ultra-thin nature of graphene also allow the application of graphene in thin and tough transparent conductive films. The single-layer graphene produces only about 2.3% of visible light loss.

From the above, it is expected that many future products, such as ultrahigh-speed transistors and transparent electrodes, can be realized using graphene. In the 2009 Material Research Society Spring Meeting, it is recognized by the attending scientists that the transparent conductive film will be realized earlier than the transistor and this is the first commercialized application of graphene in the technological field.

However, the research and development in graphene encounters two major process obstacles, a first one of which is that there has not been developed a simplified low-temperature process for producing large-area high-quality graphene, and a second one of which is that it would be difficult to transfer graphene to other material surfaces through the high-temperature process though it can produce graphene of better quality. These process obstacles largely restrict the subsequent analyses and element production.

Currently, there are several methods for producing graphene, including Scotch Tape Technique, micro-mechanical cleavage, epitaxy on single crystal silicon carbide, and chemical vapor deposition (CVD).

It would be very difficult to produce single-layer and large-area graphene using the methods of Scotch Tape Technique and micro-mechanical cleavage. Therefore, these methods largely restrict the subsequent analyses and element production, and are apparently incompatible with the current electronic industrial technologies.

While the method of epitaxy on single crystal silicon carbide can produce high-quality single-layer graphene, the ultrahigh vacuum and ultrahigh temperature required in the process are hardly achieved at low cost by the industrial field outside laboratory. Moreover, the single crystal silicon carbide wafer has a price about 100 times as high as the silicon wafer and is very difficult to produce when the size thereof is larger than 6 inches. Further, the method of epitaxy on single crystal silicon carbide is also apparently incompatible with the current industrial field that aims at mass production to produce large-area graphene. The epitaxial graphene film and silicon carbide have very strong covalent bond remained between them, and silicon carbide has very high chemical stability that could not be affected even by aqua regia. Therefore, there are few research teams that have successfully transferred the epitaxial graphene film from the silicon carbide onto other materials.

CVD has attracted researchers' attention since CVD was first used by T. Michely and his researcher team at UniVersitat zu Kö in 2006 in an attempt to synthesize graphene on iridium surface. The advantages of producing graphene using CVD include much simpler process equipment is required compared to that needed to fabricate the epitaxial graphene film, allows scale-up of the production process, and enables fabrication of large-area or large-size graphene elements. Further, graphene synthesized using CVD can have a size that appears not to be restricted by the atomic-scale roughness of the transition metal surface. That is, the atomic-scale surface roughness would not cause too many defects on graphene. Therefore, except for the still high process temperature ranged from 800 to 1000° C., CVD is currently the optimum method for growing graphene.

Graphene, no matter produced in which of the above-mentioned methods, must be positioned on an appropriate substrate to be further used in other applications. For example, to be applied to the field effect transistors, graphene must be positioned on a silicon substrate coated with an insulating layer, such as SiO₂ or Al₂O₃; or, to be applied to the transparent electrodes, graphene must be positioned on a transparent substrate, such as glass or polyethylene terephthalate (PET). Graphene can be directly transferred onto a target substrate through Scotch Tape technique or micro-mechanical cleavage. However, as having been mentioned above, the above two methods are not suitable for producing single-layer and large-area graphene and accordingly incompatible with the existing industrial technologies. As to the epitaxy on single crystal silicon carbide surface, since epitaxial graphene film and silicon carbide have very strong covalent bond remained between them, and silicon carbide has very high chemical stability that could not be affected even by aqua regia, there are few research teams that have successfully transferred the epitaxial graphene film from the silicon carbide surface onto other materials. Concerning the room-temperature graphene oxide (GO) flake spray coating method, while it is a currently highly important method for producing flexible graphene transparent electrode and has good potential for manufacturing solar cell electrode; however, it would cause a relatively large quantity of defects in graphene to result in poor performance of graphene elements.

On the other hand, through CVD, the metal substrate is wet etched and graphene is separated from the substrate to float on the etchant and can be taken out from the etchant with other substrates. Apparently, CVD is more suitable for transferring graphene in large area. However, the procedure of taking out graphene from the etchant seems to be incompatible with the current industrial technologies.

In summary, all the currently available processes, except CVD, have difficulty in transferring graphene to other material surfaces, particularly when the graphene is to be applied in the production of transparent conductive film. Particularly, the graphene oxide scatter coating method, due to the poor electrical property thereof, has very limited applications.

### SUMMARY OF THE INVENTION

To solve the problems in the conventional methods for producing and transferring graphene, it is a primary object of the present invention to provide a carbonaceous material layer transferring method and apparatus that enables rapid transfer of large-area graphene from a growth substrate onto a target substrate.

To achieve the above and other objects, the carbonaceous material layer transferring method according to the present invention includes the steps of: growing a carbonaceous material layer on a growth substrate through chemical vapor deposition (CVD); using a first continuous conveying unit to feed and attach the growth substrate and a transfer material to each other, the transfer material having a gluing layer and being attached via the gluing layer to the carbonaceous material layer; using a transformation device to change a viscosity of the gluing layer for the gluing layer to adhere to the growth substrate; using a second continuous conveying unit to convey and then separate the transfer material from the growth substrate, so that some part of the carbonaceous material layer is transferred onto the gluing layer while other part of the carbonaceous material layer remains on the growth substrate to thereby achieve the object of transferring the carbonaceous material layer.

To achieve the above and other objects, the carbonaceous material layer transferring apparatus according to the present invention includes a continuous conveying device and at least one transformation device. The continuous conveying device includes a first continuous conveying unit and a second continuous conveying unit, each of which consists of a plurality of rolls for continuously conveying and attaching a growth substrate having at least one carbonaceous material layer grown on at least one side thereof to a transfer material having at least one gluing layer provided on at least one side thereof, and then separate the mutually adhered growth substrate and transfer material from each other. The carbonaceous material layer is graphite. The transformation device is arranged in the first continuous conveying unit for changing a viscosity of the gluing layer, so that the gluing layer can firmly adhere to the carbonaceous material layer. In another embodiment of the present invention, the second continuous conveying unit further includes an etching unit for etching away the growth substrate to obtain a complete carbonaceous material layer.

With the above arrangements, the method and apparatus for transferring carbonaceous material layer according to the present invention has one or more of the following advantages:

(1) A plural layer of graphene can be deposited on a growth substrate through chemical vapor deposition, and large-area graphene can be transferred from the growth substrate onto a target substrate at high productivity using a combination of a plurality of continuous conveying devices.

(2) By controlling the pre-transfer thickness of the graphene and different parameters of the continuous conveying devices, including temperature, pressure, rotary speed, times of processing, etc., the post-transfer thickness of the graphene and the quality thereof can be precisely controlled.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view showing a first embodiment of a carbonaceous material layer transferring apparatus according to the present invention;

FIG. 2 is a flowchart showing the steps included in a first embodiment of a carbonaceous material layer transferring method according to the present invention;

FIG. 3 is a conceptual view showing a second embodiment of the carbonaceous material layer transferring apparatus according to the present invention;

FIG. 4 is a flowchart showing the steps included in a second embodiment of the carbonaceous material layer transferring method according to the present invention;

FIG. 5 is a conceptual view showing a third embodiment of the carbonaceous material layer transferring apparatus according to the present invention; and

FIG. 6 is a flowchart showing the steps included in a third embodiment of the carbonaceous material layer transferring method according to the present invention.

### DETAILED DESCRIPTION OF THE PREFERRED EMBODIMENTS

The present invention will now be described with some preferred embodiments thereof. For the purpose of easy to understand, elements that are the same in the preferred embodiments are denoted by the same reference numerals.

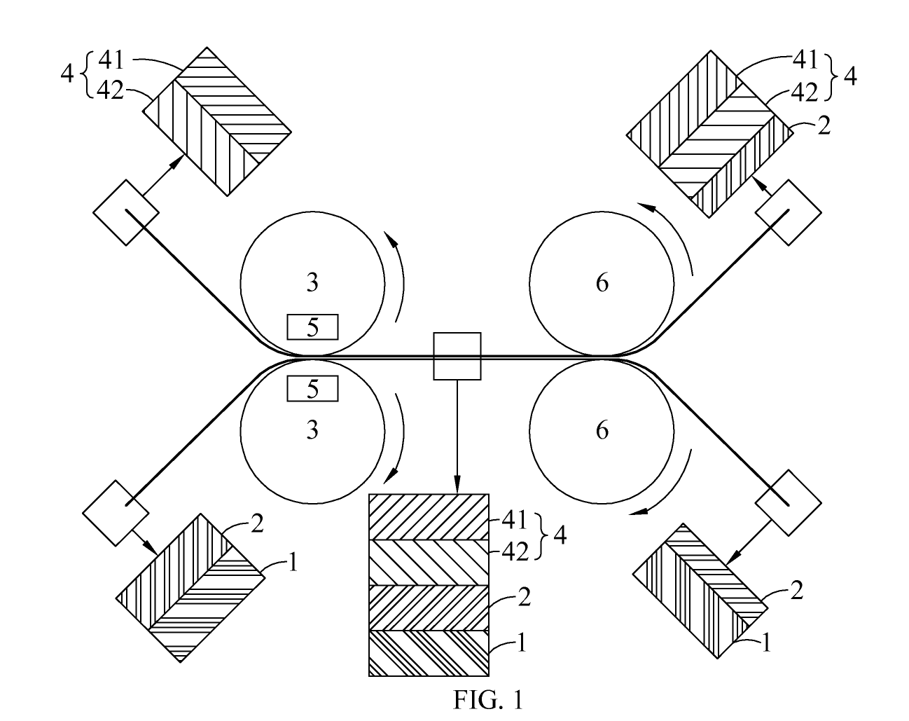

Please refer to FIG. 1 that is a conceptual view showing a first embodiment of a carbonaceous material layer transferring apparatus according to the present invention. As shown, the carbonaceous material layer transferring apparatus in the first embodiment includes a continuous conveying device, which further includes a first continuous conveying unit 3 and a second continuous conveying unit 6, and each of the first and second continuous conveying units 3 and 6 consists of a plurality of rolls; and at least one transformation device 5.

The first continuous conveying unit 3 is used to continuously feed and attach a growth substrate 1 having a carbonaceous material layer 2 grown on one side thereof to a transfer material 4 having a gluing layer 42 provided on one side thereof. In the illustrated first embodiment, the carbonaceous material layer 2 is few-layer graphene (FLG). The transformation device 5 is arranged in the first continuous conveying unit 3 for changing a viscosity of the gluing layer 42, so that the gluing layer 42 can firmly adhere to the carbonaceous material layer 2. The second continuous conveying unit 6 is used to convey and then separate the transfer material 4 and the growth substrate 1 from each other. When the transfer material 4 is separated from the growth substrate 1, some part of the carbonaceous material layer 2 is transferred onto the gluing layer 42 while other part of the carbonaceous material layer 2 remains on the growth substrate 1. Thus, the object of transferring the carbonaceous material layer 2 onto the transfer material 4 for performing subsequent transfer process is achieved.

The transformation device 5 is not necessarily arranged in the first continuous conveying unit 3, but can be otherwise arranged between the first continuous conveying unit 3 and the second continuous conveying unit 6 or in the second continuous conveying unit 6.

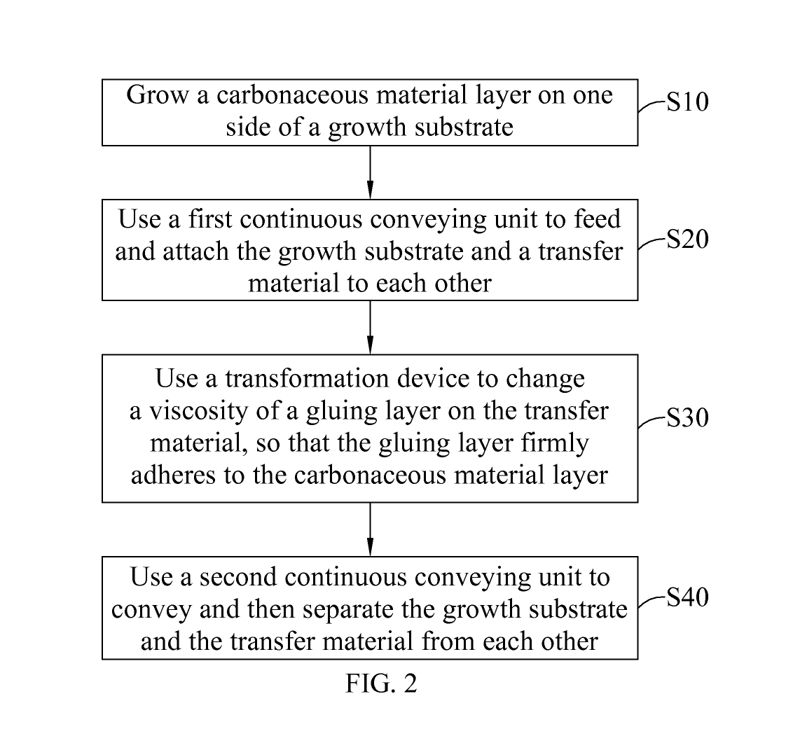

Please refer to FIG. 2 that is a flowchart showing the steps included in a first embodiment of a carbonaceous material layer transferring method according to the present invention. First, in a step S10, a carbonaceous material layer 2 is grown on one side of a growth substrate 1 through chemical vapor deposition (CVD). For example, the carbonaceous material layer 2 can be graphene and the growth substrate 1 can be a nickel metal substrate or a copper metal substrate. However, it is understood the growth substrate is not limited to the nickel metal substrate or the copper metal substrate but can be any other flexible or rigid material on which the carbonaceous material layer 2 can be grown. Preferably, the growth substrate 1 is a flexible substrate.

Then, in a step S20, the growth substrate 1 and the carbonaceous material layer 2 are simultaneously fed using a first continuous conveying unit 3 and a transfer material 4 is introduced into the first continuous conveying unit 3 at the same time, so that the transfer material 4 is attached to the carbonaceous material layer 2.

The transfer material 4 includes at least a substrate layer 41 and a gluing layer 42. The substrate layer 41 can be made of polyethylene terephthalate (PET), polyvinyl chloride (PVC), polyethylene (PE), polystyrene (PS), or any other flexible material for supporting the gluing layer 42 on one side thereof. The gluing layer 42 can be ethylene vinyl acetate (EVA) or any other gluing layer suitable for gluing the carbonaceous material layer thereto. EVA will become molten when being heated and can therefore be used as a heat-melting adhesive. The transfer material 4 is attached to the carbonaceous material layer 2 via the gluing layer 42.

Then, in a step S30, when the transfer material 4 and the growth substrate 1 are tightly pressed to attach to each other by the first continuous conveying unit 3, a transformation device 5 arranged in the first continuous conveying unit 3 is used to change a viscosity of the gluing layer 42. In the illustrated first embodiment, the transformation device 5 is a heating device that is heated to a temperature ranging between 80 and 200° C., and preferably 70 and 170° C., and more preferably 150° C., so that the gluing layer 42 is molten to thereby glue the carbonaceous material layer 2 to the transfer material 4. In the case a gluing layer 42 other than EVA is used, a different type of transformation device 5 can be adopted to change the viscosity of the gluing layer 42.

For example, the gluing layer 42 can be otherwise ultraviolet glue (UV glue), and the transformation device 5 can be a UV irradiation device corresponding to the UV glue. That is, when the gluing layer 42 is attached to the carbonaceous material layer 2, the UV irradiation device is caused to irradiate UV light to change the viscosity of the gluing layer 42, so that the gluing layer 42 adheres to the carbonaceous material layer 2.

And then, in a step S40, a second continuous conveying unit 6 is used to further convey and then separate the mutually attached transfer material 4 and growth substrate 1 from each other though physical cleavage when they are moved out of the second continuous conveying unit 6. Since the carbonaceous material layer 2 is substantially atomic-scale graphite with layer structure, some part of the carbonaceous material layer 2 is remained on the growth substrate 1 during the physical cleavage while the other part of the carbonaceous material layer 2 is transferred to the transfer material 4. Thus, the object of continuously transferring large-area carbonaceous material layer 2 can be achieved.

Further, the transformation device 5 is not necessarily arranged in the first continuous conveying unit 3 but can be otherwise arranged between the first continuous conveying unit 3 and the second continuous conveying unit 6 or in the second continuous conveying unit 6.

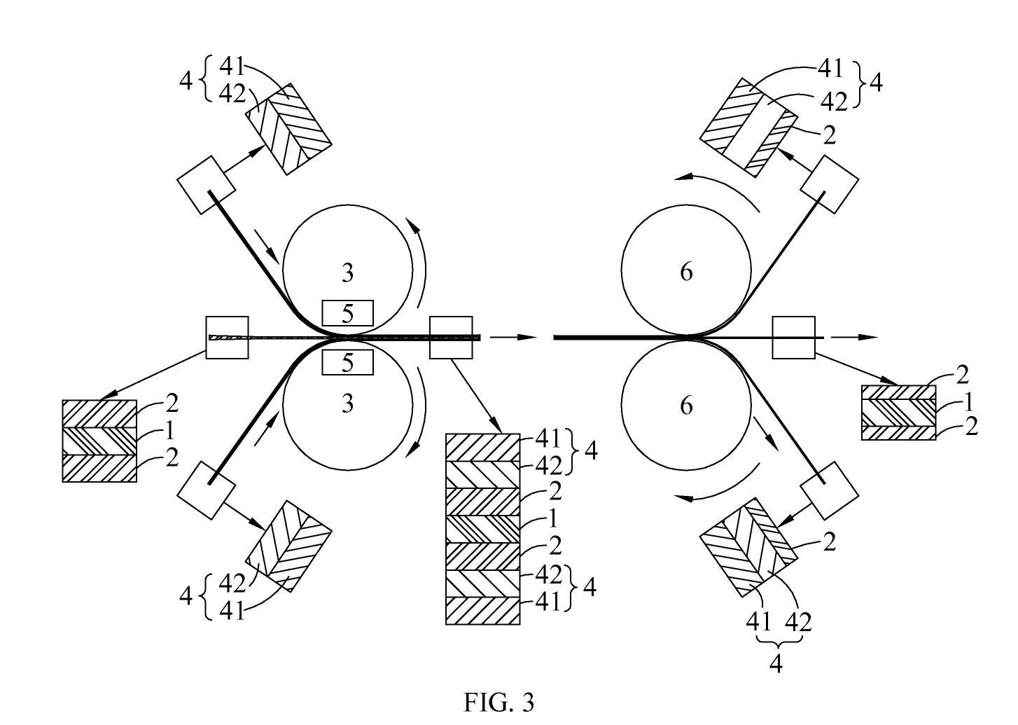

Please refer to FIG. 3 that is a conceptual view showing a second embodiment of the carbonaceous material layer transferring apparatus according to the present invention. As shown, the carbonaceous material layer transferring apparatus in the second embodiment includes a continuous conveying device, which further includes a first continuous conveying unit 3 and a second continuous conveying unit 6, and each of the first and second continuous conveying units 3 and 6 consists of a plurality of rolls; and at least one transformation device 5.

The first continuous conveying unit 3 is used to continuously feed and attach a growth substrate 1 having two carbonaceous material layers 2 separately grown on two opposite sides thereof to two transfer materials 4 each having a gluing layer 42 provided on one side thereof. In the illustrated second embodiment, the carbonaceous material layers 2 are graphene. The transformation device 5 is arranged in the first continuous conveying unit 3 for changing a viscosity of the gluing layers 42, so that the gluing layers 42 can separately firmly adhere to the carbonaceous material layers 2. The second continuous conveying unit 6 is used to further convey and then separate the two transfer materials 4 from the growth substrate 1. When the two transfer materials 4 are separated from the growth substrate 1, some part of the carbonaceous material layers 2 transfers onto the gluing layers 42 while other part of the carbonaceous material layers 2 remains on the growth substrate 1. Thus, the object of transferring the carbonaceous material layers 2 to the transfer materials 4 for performing subsequent transfer process is achieved.

The transformation device 5 is not necessarily arranged in the first continuous conveying unit 3, but can be otherwise arranged between the first continuous conveying unit 3 and the second continuous conveying unit 6 or in the second continuous conveying unit 6.

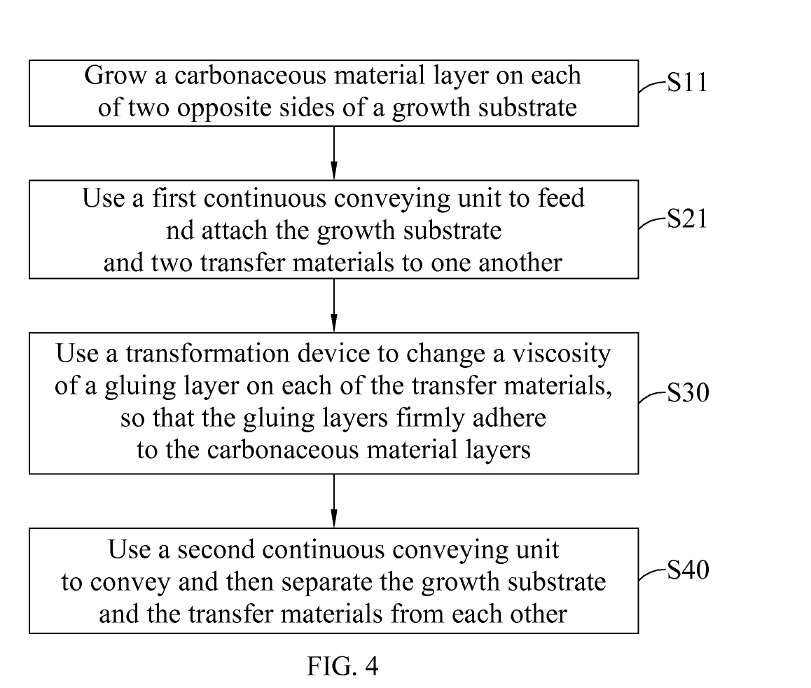

Please refer to FIG. 4 that is a flowchart showing the steps included in a second embodiment of a carbonaceous material layer transferring method according to the present invention. First, in a step S11, two carbonaceous material layers 2 are separately grown on opposite upper and lower sides of a growth substrate 1. In the illustrated second embodiment, the carbonaceous material layers 2 are graphene and the growth substrate 1 is a nickel metal substrate or a copper metal substrate. However, it is understood the growth substrate 1 is not limited to the nickel metal substrate or the copper metal substrate but can be any other flexible or rigid material on which the carbonaceous material layers 2 can be grown. Preferably, the growth substrate 1 is a flexible substrate.

Then, in a step S21, use a first continuous conveying unit 3 to simultaneously feed the growth substrate 1 and two separate transfer materials 4, so that the two separate transfer materials 4 are separately attached to the upper and the lower side of the growth substrate 1. Each of the two transfer materials 4 has a gluing layer 42 provided on one side thereof. As in the first embodiment of the carbonaceous material layer transferring method, the two transfer materials 4 are separately attached to the two carbonaceous material layers 2 via respective gluing layer 42.

The transfer materials 4 each include at least a substrate layer 41 and a gluing layer 42. The substrate layer 41 can be made of polyethylene terephthalate (PET), polyvinyl chloride (PVC), polyethylene (PE), polystyrene (PS), or any other flexible composite material for supporting the gluing layers 42 on two sides thereof. The gluing layers 42 each can be ethylene vinyl acetate (EVA) or any other gluing layer suitable for gluing the carbonaceous material layers thereto. EVA will become molten when being heated and can therefore be used as a heat-melting adhesive. The transfer materials 4 are attached to the carbonaceous material layers 2 via the gluing layers 42.

Then, in a step S30, when the transfer materials 4 and the growth substrate 1 are fed into and tightly pressed to attach to each other by the first continuous conveying unit 3, use a transformation device 5 arranged in the first continuous conveying unit 3 to change a viscosity of the gluing layers 42, so that the gluing layers 42 separately firmly adhere to the carbonaceous material layers 2. In the illustrated second embodiment, the transformation device 5 is a heating device that is heated to a temperature ranging between 80 and 200° C., and preferably 70 and 170° C., and more preferably 150° C., so that the gluing layers 42 are molten to thereby adhere to the carbonaceous material layers 2. In the case two gluing layers 42 other than EVA are used, a different type of transformation device 5 can be adopted to change the viscosity of the gluing layers 42.

For example, the gluing layers 42 can be otherwise ultraviolet glue (UV glue), and the transformation device 5 can be a UV irradiation device corresponding to the UV glue. That is, when the gluing layers 42 have been attached to the carbonaceous material layers 2, the UV irradiation device is caused to irradiate UV light to change the viscosity of the gluing layers 42, so that the gluing layers 42 adhere to the carbonaceous material layers 2.

And then, in a step S40, use a second continuous conveying unit 6 to continuously convey the mutually attached transfer materials 4 and growth substrate 1 and then separate the transfer materials 4 from the growth substrate 1 though physical cleavage when they are moved out of the second continuous conveying unit 6. Since the carbonaceous material layers 2 are substantially atomic-scale graphite with layer structure, some part of each of the carbonaceous material layers 2 is remained on the growth substrate 1 during the physical cleavage while the other part of each of the carbonaceous material layers 2 is transferred onto the transfer materials 4. According to the second embodiment of the carbonaceous material layer transferring method of the present invention, it is able to obtain productivity twice as high as that of the first embodiment. Further, a plural set of first and second continuous conveying units 3, 6 can be provided to achieve the object of continuously transferring at least one carbonaceous material layer 2 onto the transfer material 4 for performing various subsequent processes in which the carbonaceous material layers are applied.

Further, the transformation device 5 is not necessarily arranged in the first continuous conveying unit 3 but can be otherwise arranged between the first continuous conveying unit 3 and the second continuous conveying unit 6 or in the second continuous conveying unit 6.

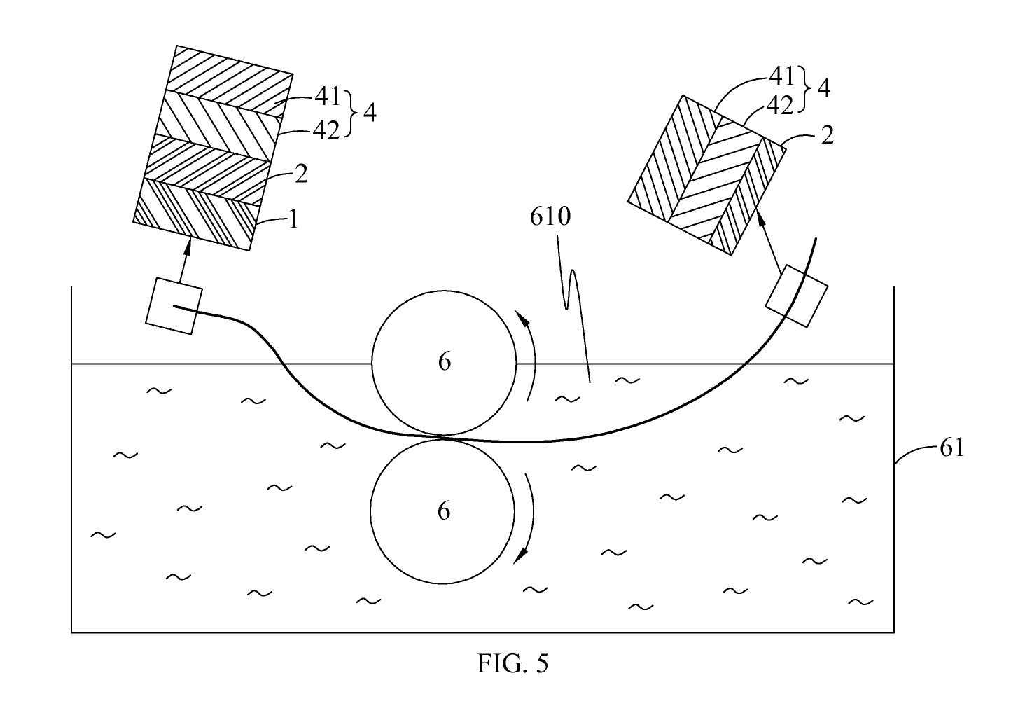

Please refer to FIG. 5 that is a conceptual view showing a third embodiment of the carbonaceous material layer transferring apparatus according to the present invention. As shown, the carbonaceous material layer transferring apparatus in the third embodiment includes a continuous conveying device, which further includes a first continuous conveying unit 3 (not shown in FIG. 5) and a second continuous conveying unit 6, each of the first and second continuous conveying units 3 and 6 consists of a plurality of rolls, and the second continuous conveying unit 6 further includes an etching unit 61 having an etchant 610 contained therein; and at least one transformation device 5 (not shown in FIG. 5).

The first continuous conveying unit 3 is used to continuously feed and attach a growth substrate 1 having a carbonaceous material layer 2 grown on one side thereof to a transfer material 4 having a gluing layer 42 provided on one side thereof. In the illustrated third embodiment, the carbonaceous material layer 2 is graphene. The transformation device 5 is arranged in the first continuous conveying unit 3 for changing a viscosity of the gluing layer 42, so that the gluing layer 42 can firmly adhere to the carbonaceous material layer 2. The second continuous conveying unit 6 is used to convey the mutually adhered growth substrate 1 and transfer material 4 into the etching unit 61 for performing an etching process on the growth substrate 1, and, when the etching of the growth substrate 1 is completed, move the transfer material 4 having the carbonaceous material layer 2 transferred thereto out of the etching unit 61. In this method, the object of transferring the complete carbonaceous material layer 2 onto the transfer material 4 can be achieved.

Further, the transformation device 5 is not necessarily arranged in the first continuous conveying unit 3 but can be otherwise arranged between the first continuous conveying unit 3 and the second continuous conveying unit 6 or in the second continuous conveying unit 6.

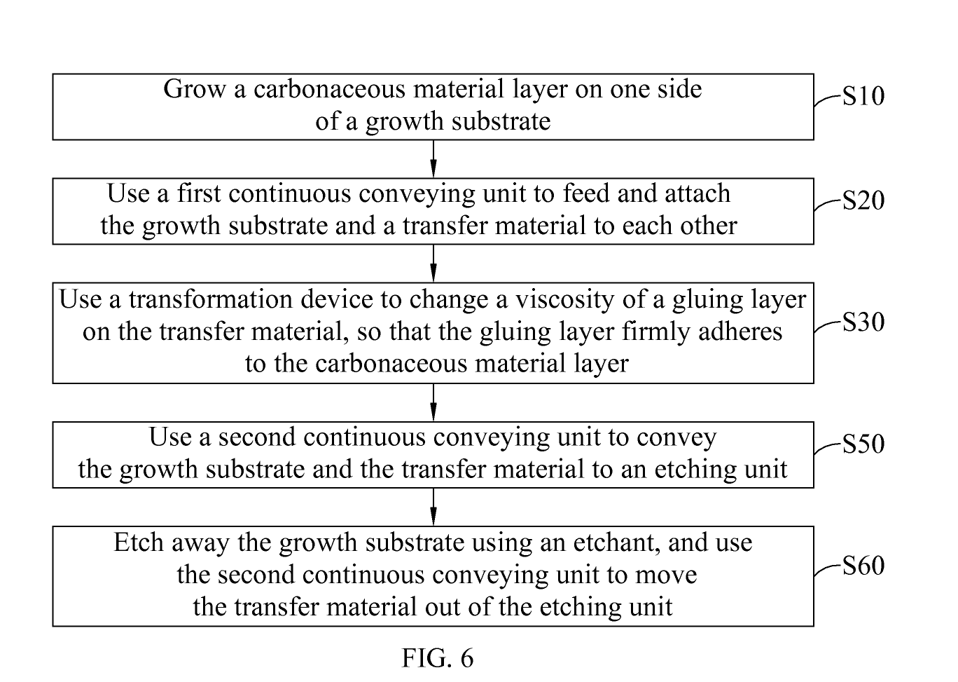

FIG. 6 is a flowchart showing the steps included in a third embodiment of the carbonaceous material layer transferring method according to the present invention. First, in a step S10, a carbonaceous material layer 2 is grown on one side of a growth substrate 1 through any one of various carbonaceous material layer deposition processes, including the chemical vapor deposition (CVD). In the illustrated third embodiment of the carbonaceous material layer transferring method, the carbonaceous material layer 2 is graphene and the growth substrate 1 can be a nickel metal substrate or a copper metal substrate. However, it is understood the growth substrate 1 is not limited to the nickel metal substrate or the copper metal substrate but can be any other flexible or rigid material on which the carbonaceous material layer 2 can be grown. Preferably, the growth substrate 1 is a flexible substrate.

Then, in a step S20, the growth substrate 1 and the carbonaceous material layer 2 are simultaneously fed using a first continuous conveying unit 3 and a transfer material 4 is introduced into the first continuous conveying unit 3 at the same time, so that the transfer material 4 is attached to the carbonaceous material layer 2.

The transfer material 4 includes at least a substrate layer 41 and a gluing layer 42. The substrate layer 41 can be made of polyethylene terephthalate (PET), polyvinyl chloride (PVC), polyethylene (PE), polystyrene (PS), or any other flexible material for supporting the gluing layer 42 on one side thereof. The gluing layer 42 can be ethylene vinyl acetate (EVA) or any other gluing layer suitable for gluing the carbonaceous material layer thereto. EVA will become molten when being heated and can therefore be used as a heat-melting adhesive. The transfer material 4 is attached to the carbonaceous material layer 2 via the gluing layer 42.

Then, in a step S30, when the transfer material 4 and the growth substrate 1 are tightly pressed to attach to each other by the first continuous conveying unit 3, a transformation device 5 arranged in the first continuous conveying unit 3 is used to change a viscosity of the gluing layer 42. In the illustrated third embodiment, the transformation device 5 is a heating device that is heated to a temperature ranging between 80 and 200° C., and preferably 70 and 170° C., and more preferably between 75 and 135° C. in the case the gluing layer 42 is EVA, so that the gluing layer 42 (EVA) is molten to thereby adhere to the carbonaceous material layer 2. In the case a gluing layer 42 other than EVA is used, a different type of transformation device 5 can be adopted to change the viscosity of the gluing layer 42.

For example, the gluing layer 42 can be otherwise ultraviolet glue (UV glue), and the transformation device 5 can be a UV irradiation device corresponding to the UV glue. That is, when the gluing layer 42 has been attached to the carbonaceous material layer 2, the UV irradiation device is caused to irradiate UV light to change the viscosity of the gluing layer 42, so that the gluing layer 42 adheres to the carbonaceous material layer 2.

Then, in a step S50, when the transfer material 4 has been adhered to the growth substrate 1 via the gluing layer 42, a second continuous conveying unit 6 is used to guide the mutually attached transfer material 4 and growth substrate 1 into an etching unit 61, in which an etchant 610 is contained. The etchant 610 can be nitric acid (HNO₃), hydrochloric acid (HCl), ferric chloride (FeCl₃) solution, or any other liquid that can be used to corrode or dissolve the growth substrate 1, and is used to etch away the metal growth substrate 1, so that there is no longer any adhesion power or binding force between the growth substrate 1 and the carbonaceous material layer 2.

Alternatively, the etching unit 61 can have an etching gas contained therein for etching away or dissolve the growth substrate 1.

Further, the transformation device 5 is not necessarily arranged in the first continuous conveying unit 3 but can be otherwise arranged between the first continuous conveying unit 3 and the second continuous conveying unit 6 or in the second continuous conveying unit 6.

Then, in a step S60, when the growth substrate 1 has been completely etched away or when there is no longer any adhesion power or binding force between the growth substrate 1 and the carbonaceous material layer 2, and only the carbonaceous material layer 2 is adhered to the gluing layer 42 on the transfer material 4, the transfer material 4 having the carbonaceous material layer 2 adhered thereto is moved out of the etching unit 61 using the second continuous conveying unit 6. Unlike the first and second embodiments, in which some part of the carbonaceous material layer(s) will still remain on the growth substrate 1, the third embodiment of the carbonaceous material layer transferring method enables the whole carbonaceous material layer 2 to be transferred from the growth substrate 1 onto the transfer material 4. In the third embodiment of the carbonaceous material layer transferring method, various carbonaceous material layer deposition processes, including the CVD process, can be further adopted to precisely deposit several layers or even only one layer of the carbonaceous material layer 2 on the transfer material 4, so as to achieve the object of continuously transferring at least one carbonaceous material layer 2 to the transfer material 4 for performing various subsequent processes in which the carbonaceous material layers are applied.

In the present invention, the first and the second continuous conveying unit 3, 6 each include a plurality of rolls, and the process of using the first continuous conveying unit 3 and the second continuous conveying unit 6 to convey the growth substrate 1 and the transfer material(s) 4 is also referred to a Roll-to-Roll process. Through the steps included in the carbonaceous material layer transferring method of the present invention, it is able to continuously transfer large-area carbonaceous material layer 2 from the growth substrate 1 onto the transfer material 4 in a large-scale production, and the large-area carbonaceous material layer 2 transferred onto the transfer material 4 can be used in subsequent transfer process to be further transferred onto a target substrate.

In the subsequent transfer process, the carbonaceous material layer 2, which is graphene in the illustrated embodiments of the present invention and has been primarily transferred to the transfer material 4, can be further transferred to a substrate, particularly a transparent substrate, such as a glass substrate, through pattern transfer processes using different techniques, such as mask process or photolithography process. Due to its excellent electrical conductivity and extremely high transmittance of light, the carbonaceous material layer, i.e. the graphene, is a very good material for making transparent electrodes for display devices and has been considered as a highly potential material that can replace the ITO to be used as a new-generation material for transparent electrodes.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A carbonaceous material layer transferring method, comprising the following steps:
growing at least one carbonaceous material layer on at least one side of a growth substrate;
using a first continuous conveying unit to feed and attach the growth substrate and at least one transfer material to each other, the transfer material including a substrate layer and a gluing layer supported on at least one side of the substrate layer, and the gluing layer being used to attach to the carbonaceous material layer;
using at least one transformation device to change a viscosity of the gluing layer, so that the gluing layer glues the transfer material to the carbonaceous material layer on the growth substrate; and
using a second continuous conveying unit to convey and then separate the transfer material and the growth substrate from each other, such that some part of the carbonaceous material layer is transferred onto the gluing layer while other part of the carbonaceous material layer remains on the growth substrate.

2. The carbonaceous material layer transferring method as claimed in claim 1, wherein the growth substrate is selected from the group consisting of a nickel metal substrate and a copper metal substrate.

3. The carbonaceous material layer transferring method as claimed in claim 1, wherein the carbonaceous material layer is a graphite structure.

4. The carbonaceous material layer transferring method as claimed in claim 3, wherein the graphite structure is graphene.

5. The carbonaceous material layer transferring method as claimed in claim 1, wherein the substrate layer of the transfer material is selected from the group consisting of polyethylene terephthalate (PET), polyvinyl chloride (PVC), polyethylene (PE), polystyrene (PS), and composite materials thereof.

6. The carbonaceous material layer transferring method as claimed in claim 1, wherein the gluing layer is a thin film of ethylene vinyl acetate (EVA).

7. The carbonaceous material layer transferring method as claimed in claim 1, wherein the transformation device is arranged in a growth substrate and transfer material transferring path, including the first and the second continuous conveying unit.

8. The carbonaceous material layer transferring method as claimed in claim 7, wherein the transformation device is a heating device.

9. The carbonaceous material layer transferring method as claimed in claim 8, wherein the heating device is heated to a temperature ranging between 80 and 200° C.

10. The carbonaceous material layer transferring method as claimed in claim 9, wherein the heating device is heated to a temperature of 150° C.

11. The carbonaceous material layer transferring method as claimed in claim 5, wherein the gluing layer is UV glue.

12. The carbonaceous material layer transferring method as claimed in claim 11, wherein the transformation device is an ultraviolet irradiation device.

13. The carbonaceous material layer transferring method as claimed in claim 1, wherein the first and the second continuous conveying unit each include a plurality of rolls.

14. The carbonaceous material layer transferring method as claimed in claim 13, wherein the second continuous conveying unit further includes an etching unit for performing an etching process to etch away the growth substrate.

15. The carbonaceous material layer transferring method as claimed in claim 14, wherein the etching process uses an etching liquid, which is selected from the group consisting of nitric acid, hydrochloric acid, and ferric chloride.

16. A carbonaceous material layer transferring apparatus, comprising:
a continuous conveying device including:
a first continuous conveying unit for continuously feeding and attaching a growth substrate having at least one carbonaceous material layer grown on at least one side thereof to at least one transfer material having at least one gluing layer provided on at least one side thereof; and
a second continuous conveying unit for continuously conveying and then separating the mutually adhered growth substrate and transfer material from each other; and
at least one transformation device being arranged in a growth substrate and transfer material transferring path, including the first and the second continuous conveying unit, for changing a viscosity of the gluing layer, so that the gluing layer firmly adheres to the carbonaceous material layer.

17. The carbonaceous material layer transferring apparatus as claimed in claim 16, wherein the growth substrate is selected from the group consisting of a nickel metal substrate and a copper metal substrate.

18. The carbonaceous material layer transferring apparatus as claimed in claim 16, wherein the carbonaceous material layer is a graphite structure.

19. The carbonaceous material layer transferring apparatus as claimed in claim 18, wherein the graphite structure is graphene.

20. The carbonaceous material layer transferring apparatus as claimed in claim 16, wherein the transfer material further includes a substrate layer, on which the gluing layer is supported.

21. The carbonaceous material layer transferring apparatus as claimed in claim 20, wherein the substrate layer is selected from the group consisting of polyethylene terephthalate (PET), polyvinyl chloride (PVC), polyethylene (PE), polystyrene (PS), and composite materials thereof.

22. The carbonaceous material layer transferring apparatus as claimed in claim 16, wherein the gluing layer is a thin film of ethylene vinyl acetate (EVA).

23. The carbonaceous material layer transferring apparatus as claimed in claim 16, wherein the transformation device is a heating device.

24. The carbonaceous material layer transferring apparatus as claimed in claim 23, wherein the heating device is heated to a temperature ranging between 80 and 200° C.

25. The carbonaceous material layer transferring apparatus as claimed in claim 24, wherein the heating device is heated to a temperature of 150° C.

26. The carbonaceous material layer transferring apparatus as claimed in claim 16, wherein the gluing layer is UV glue.

27. The carbonaceous material layer transferring apparatus as claimed in claim 26, wherein the transformation device is an ultraviolet irradiation device.

28. The carbonaceous material layer transferring apparatus as claimed in claim 16, wherein the first and the second continuous conveying unit each include a plurality of rolls.

29. The carbonaceous material layer transferring apparatus as claimed in claim 16, wherein the second continuous conveying unit further includes an etching unit for performing an etching process to etch away the growth substrate.

30. The carbonaceous material layer transferring apparatus as claimed in claim 29, wherein the etching process uses an etching liquid, which is selected from the group consisting of nitric acid, hydrochloric acid, and ferric chloride.
